(19) United States
(12) Patent Application Publication
(10) Pub. No.: US 2004/0203365 A1
(43) Pub. Date: Oct. 14, 2004

(54) Radio communication with an intended device

(76) Inventors: Tetsuya Yamamoto, Chiba (JP); Jan Chipchase, Tokyo (JP)

Correspondence Address: SCHEEF & STONE, L.L.P., 5956 SHERRY LANE, SUITE 1400, DALLAS, TX, 75225, US

(21) Appl. No.: 10/171,112

(22) Filed: Jun. 13, 2002

(51) Int. Cl. H04B 5/00

(52) U.S. Cl. 455/41.2

(57) ABSTRACT

Bringing one radio communication device into a predetermined close physical relationship with another radio communication device, indicates an intent for radio communication to occur between the devices. The predetermined physical relationship may involve the alignment of the devices, the attraction of the devices together so that they touch or physical separtion of less than a few centimetres. Sensing means may be used for sensing the predetermined physical relationship.

### BACKGROUND OF THE INVENTION

A radio communication device is typically capable of communicating with any one of a plurality of other radio communication devices (receivers, transmitters or transceivers) which are within range. Consequently, at any time the radio communication device may be capable of communicating with a large number of other devices. If a user of the radio communication device wishes to communicate with a specific one of the plurality of devices within range, it may be difficult for the user to ensure that he or she is communicating with the correct device.

It would be desirable to allow a user to ensure that he or she is communicating with the intended device.

### BRIEF SUMMARY OF THE INVENTION

In embodiments of the invention, bringing one radio communication device into a predetermined close physical relationship with another radio communication device, indicates an intent for radio communication to occur between the devices.

In one embodiment, the predetermined physical relationship involves the alignment of the devices and a communication device may have alignment means for aligning it with another communication device. The alignment means may be a part of a replaceable cover.

In another embodiment, the predetermined physical relationship involves the attraction of the devices together and a communication device may have attraction means for attracting it to another communication device so that the devices touch. The attraction means may be a part of a replaceable cover.

In another embodiment, the predetermined physical relationship involves physical separtion of less than a few centimetres, but does not include separation of many metres, and a communication device may have a mode in which it is capable of communicating only a few centimetres.

In other embodiments of the invention, a communication device comprises sensing means for sensing the existence of a predetermined physical relationship between it and another communication device and control means for controlling it to communicate with the sensed communication device. The sensing means may be a part of a replaceable cover.

The radio communication devices may be transmitters, receivers or transceivers.

For a better understanding of the present invention reference will now be made by way of example only to the accompanying drawings.

### BRIEF DESCRIPTION OF SEVERAL VIEWS OF THE DRAWINGS

FIG. 1 illustrates an arrangement of low power radio frequency transceivers;

FIG. 2 schematically illustrates a first embodiment of the present invention;

FIG. 3 schematically illustrates one possible implementation of the sensors of the first embodiment;

FIG. 4 illustrates a second possible implementation of the sensors of the first embodiment;

FIG. 5 schematically illustrates a third possible implementation of the sensors of the first embodiment;

FIG. 6 schematically illustrates a second embodiment of the present invention;

FIG. 7 is a flow diagram illustrating the method of the present invention;

FIG. 8 is an embodiment in which the radio transceiver devices has a functional replaceable cover.

### DETAILED DESCRIPTION OF THE INVENTION

The following detailed description will describe in detail how a user can insure that a radio communication device is communicating with the intended one of a plurality of radio communication devices. In the following examples, radio transceiver devices will be used as exemplary radio communication devices. However, it should be borne in mind that embobiments of the invention additionally relate to: communication between a radio receiver device and one of a plurality of radio transmitter and/or radio transceiver devices; communication between a radio transmitter device and one of a plurality of radio receiver and/or radio transceiver devices; communication between a radio transceiver device and one of a plurality of radio transmitter and/or radio transceiver devices; communication between a radio transceiver device and one of a plurality of radio receiver and/or radio transceiver devices.

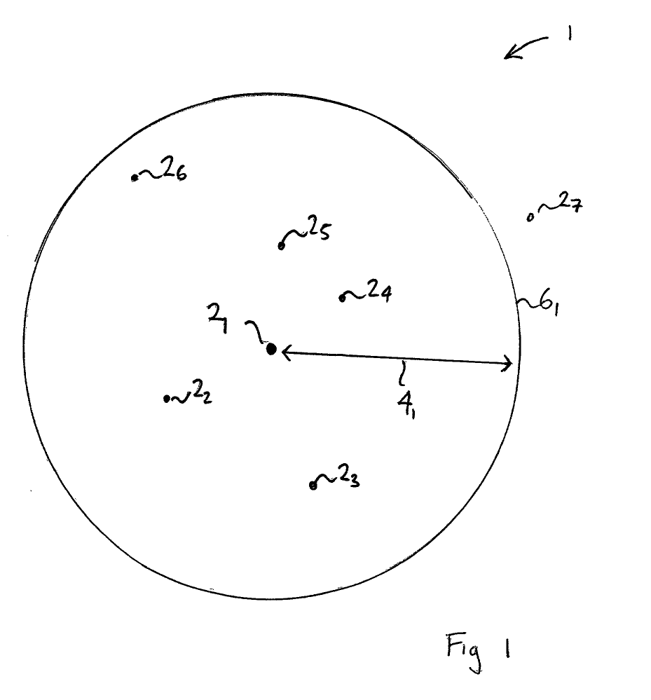

FIG. 1 illustrates an arrangement 1 of radio transceiver devices 2₁, 2₂, 2₃, 2₄, 2₅, 2₆ and 2₇ The figure also illustrates the communication range 4₁ of the radio transceiver device 2₁. The radio transceiver device 2₁ can communicate wirelessly with the plurality of radio transceiver devices 2₂, 2₃, 2₄, 2₅ and 2₆ which lie within the sphere 6₁ which is centred on the radio transceiver device 2₁ and has a radius defined by the communication range 4₁. The radio transceiver device 2₇ lies outside the circle 6₁ and it cannot communicate with the radio transceiver device 2₁. The radio transceiver devices 2ₙ illustrated in FIG. 1 are low power transceiver devices, such as Bluetooth (trade mark) devices. Consequently, the communication range 4₁ of the radio transceiver device 2₁ has a magnitude of a few meters to a few tens of meters.

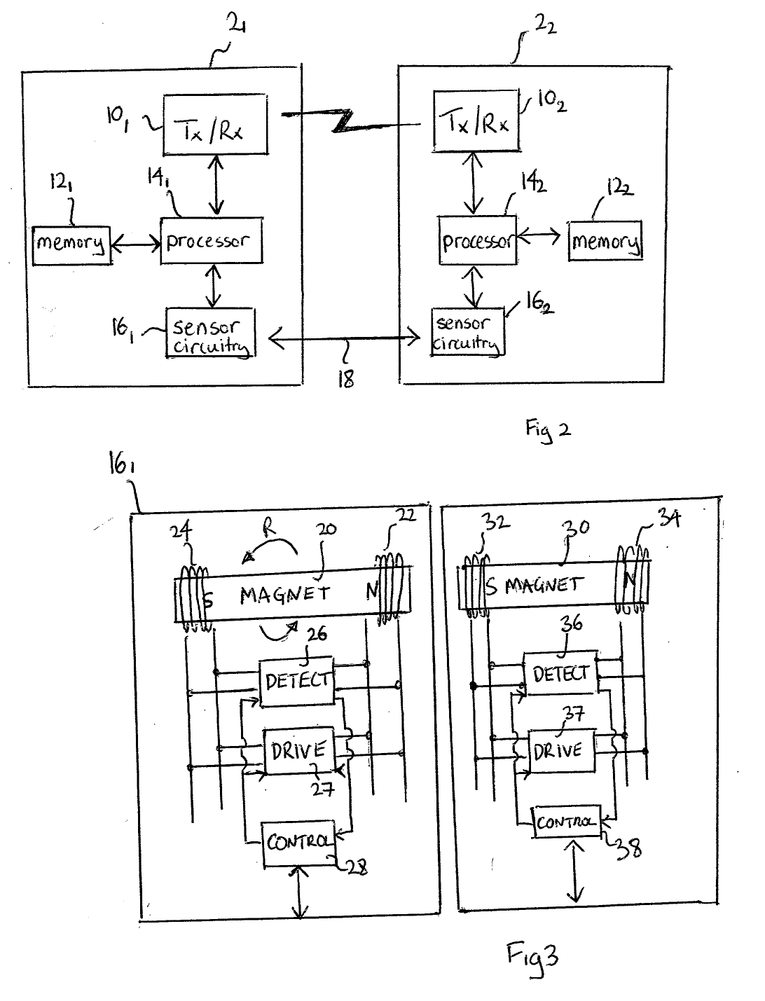

FIG. 2 illustrates the radio transceiver device 2₁ in more detail. It also illustrates another radio transceiver device 2₂ which has been brought into a predetermined intimate physical relationship with the radio transceiver device 2₁. The radio transceiver device 2₁ comprises low power radio transceiver circuitry 10₁, a memory 12₁, a processor 14₁ and sensor circuitry 16₁. The processor 14₁ is electrically connected to each of the low power radio transceiver circuitry 10₁, the memory 12₁ and the sensor circuitry 16₁ and is able to send and receive signals along each of these connections. The second radio transceiver device 2₂ comprises low power radio transceiver circuitry 10₂, a memory 12₂, a processor 14₂ and sensor circuitry 16₂. The processor 14₂ is electrically connected to each of the low power radio transceiver circuitry 10₂ the memory 12₂ and the sensor circuitry 16₂ and is capable of transmitting and receiving signals along each of these electrical connections. The low power radio transceiver circuitry 10₁ and the low power radio and transceiver circuitry 10₂ are capable of communicating with each other according to a predetermined communication protocol, preferably, that prescribed by the Bluetooth (trade mark) standard. The processor 14₁ controls the low power radio transceiver circuitry 10₁. The processor 14₁ provides a packet of data to the low power radio transceiver circuitry 10₁ for transmission. The packet data provided includes a header which comprises the identity of the intended destination of the transmitted packet. In the example of FIG. 2, the header will identify the second radio transceiver device 2₂ using, for example, its Bluetooth address.

Consequently, before the radio transceiver device 2₁ can start radio communication with the second radio transceiver device 2₂, it must identify that device so that any future radio communications can use the correct identity of that device in the header of the data packets transmitted. The sensor circuitry 16₁ detects whether or not there is a radio transceiver device in a predetermined intimate physical relationship with the radio transceiver device 2₁ and identifies the detected device. The identification of the device may occur automatically, that is without user intervention, after the existence of the predetermined intimate physical relationship has been sensed. The sensor circuitry 16₁ of the radio transceiver device 2₁ interacts 18 with the sensor circuitry 16₂ of the second radio transceiver device 2₂ to perform the detection and identification.

FIG. 3 schematically illustrates a first embodiment of the sensor circuitry 16₁ of the radio transceiver device 2₁. The sensor circuitry 16₁ comprises a permanent magnet 20 which is positioned at or close to the surface of the radio transceiver device 2₁. The magnet 20 is a bar magnet with a north pole and a south pole. A first wire coil 22 surrounds the north pole of the magnet 20 and a second wire coil 24 surrounds the south pole of the magnet 20. The first wire coil 22 and the second wire coil 24 are both separately connected to detector circuitry 26 and to drive circuitry 27. Control circuitry 28 is connected to both the detector circuitry 26 and the drive circuitry 27 and has an interface to the processor 14₁. Also illustrated in the Figure is the sensor circuitry 16₂ of the second radio transceiver device 2₂. The sensor circuitry 16₂ comprises a permanent bar magnet 30 having a north pole and a south pole. A first wire coil 32 surrounds the south pole and a second wire coil 34 surrounds the north pole. The bar magnet 30 is positioned at or close to the surface of the second radio transceiver device 2₂. The first wire coil 32 and the second wire coil 34 are both connected to detector circuitry 36 and to drive circuitry 37. Control circuitry 38 is connected to the drive circuitry 37 and to the detector circuitry 36 and has an interface to the processor 14₂.

In the Figure, the bar magnet 20 of the sensor circuitry 16₁ has its north pole at or close to the surface of the radio transceiver device 2₁. The bar magnet 20 may be mounted for rotation R so that either its north pole or its south pole is at or close to the surface of the radio transceiver device 2₁. The south pole of the bar magnet 30 of the sensor circuitry 16₂ is at or close to the surface of the second radio transceiver device 2₂. When the south pole of the magnet 30 is brought close to the north pole of the magnet 20 the inductance of the first coil 22 changes. This change in the inductance of the first coil 22 is detected by detector circuitry 26 which informs the control circuitry 28. Likewise, the inductance of the first coil 32 of the sensor circuitry 16₂ also has a change in its inductance which is detected by the detector circuitry 36 which in turn informs the control circuitry 38. The control circuitry 38 then controls the drive circuitry 37 to modulate a current in the first coil 32. The modulating current in the first coil 32 induces an equivalently modulating current in the first coil 22 of the sensor circuitry 16₁. The detector circuitry 26 detects the modulation of the induced current. In this way, the control circuitry 38 of the sensor circuitry 16₂ can transfer data identifying the second radio transceiver device 2₂ to the radio transceiver device 2₁. The detector circuitry 26 obtains the identity of the second radio transceiver device 2₂ and provides it to the control circuitry 28 which in turn provides it to the processor 14₁. The processor 14₁ on receiving the identity of the second radio transceiver device 2₂, controls the low power radio transceiver circuitry 10₁ to transmit packets to the low power radio transceiver circuitry 10₂ of the second radio transceiver device 2₂ using radio packets having a header comprising the identity of the second radio transceiver device 2₂. The control circuitry 28 of the sensor circuitry 16₁ can then, via the drive circuitry 27, modulate a current in the first coil 22 and thereby transfer its identity to the second radio transceiver device 2₂.

When the second radio transceiver device 2₂ is brought into the predetermined intimate physical relationship with the radio transceiver device 2₁ the north pole of the permanent magnet 20 attracts the south pole of the permanent magnet 30 and the two devices are drawn together. The user of the radio transceiver device 2₁ consequently feels an attractive force between the two devices which provides a positive physical feedback thereby indicating to the user that it is communicating with the second radio transceiver device 2₂. Preferably, the north pole of the permanent magnet 20 is exposed at the surface of the radio transceiver device 2₁ and the south pole of the permanent magnet 30 is exposed at the surface of the second radio transceiver device 2₂. When the radio transceiver devices are brought together, the north pole of the magnet 22 is drawn into a touching relationship with the south pole of the magnet 30. When the magnets 20 and 30 abut there is a satisfying contact noise which also provides a feedback to the user of the radio transceiver device 2₁.

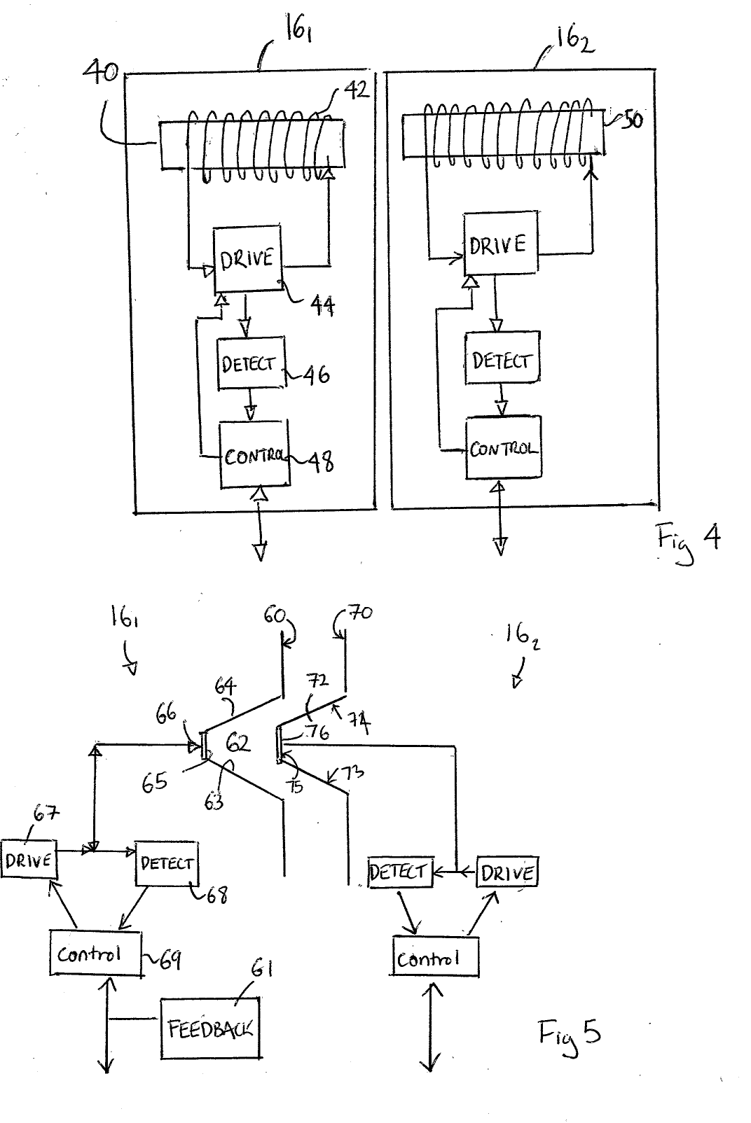

FIG. 4 illustrates a second embodiment of the sensor circuitry 16₁. The sensor circuitry 16₁ comprises a ferro-magnetic core 40 which is close to or at the surface of the radio transceiver device 2₁. The ferro-magnetic core 40 is surrounded by a wire coil 42 which is connected to drive circuitry 44. The drive circuitry 44 receives an input from control circuitry 48 and provides an output to detect circuitry 46. The detect circuitry 46 provides an output to the control circuitry 48 which has an interface to the processor 14₁. Also illustrated is the sensor circuitry of the second radio transceiver device 2₂ this sensor circuitry 16₂ comprises a ferro-magnetic core 50 which is at or close to the surface of the second radio transceiver device 2₂. The wire coil 52 surrounds the ferro-magnetic core 50 and is connected to drive circuitry 54. Control circuitry 48 provides an input to the drive circuitry 44. The drive circuitry 44 provides an output to detect circuitry 46. Detect circuitry 46 provides an output to control circuitry 48 which has an interface to the processor 14₂.

The wire coil 42 is energised by the drive circuitry 44 and consequently while the wire coil 42 is energised the ferro-magnetic core 40 operates as a magnet with a north pole and a south pole. In the same way, the drive circuitry 54 energises the wire coil 52 surrounding the ferro-magnetic core 50. While the wire coil 52 is energised the ferro-magnetic core 50 operates as a bar magnet with a north pole and a south pole. When the portion of the ferro-magnetic core 40 at or close to a surface of the radio transceiver device 2₁ acts as a north pole and a portion of the ferro-magnetic core 50 at or close to the surface of the second radio transceiver device 2₂ acts as a south pole, the radio transceiver device 2₁ and the second radio transceiver device 2₂ are attracted towards each other into a predetermined intimate physical relationship. This intimate physical relationship causes the inductance of the wire coil 42 to change which is detected by the detection circuitry 46. The drive circuitry 54 of the second radio transceiver device 2₂ under the control of the control circuitry 58 can modulate the current in the wire coil 52 and therefore modulate the effective inductance of the wire coil 42. The modulation of the effective inductance of the wire coil 42 is detected by detection circuitry 46. In this way, the second radio transceiver device 2₂ can transfer to the radio transceiver device 2₁ its identity. The detection circuitry 46 determines the identity of the device to which the radio transceiver device 2₁ is in an intimate physical relationship and provides this information to the control circuitry 48 which in turn provides it to the processor 14₁. Consequently, the processor 14₁ is capable of controlling the low power radio transceiver circuitry 10₁ to communicate with the low power radio transceiver circuitry 10₂ of the second radio transceiver device 2₂.

It will therefore be appreciated that in the embodiment described in FIGS. 3 and 4, the sensor circuitry 16₁ and the sensor circuitry 16₂ have corresponding magnetic circuits. When the second radio transceiver device 2₂ is brought into a predetermined intimate physical relationship with the radio transceiver device 2₁, the magnetic circuit of the sensor circuitry 16₂ affects the magnetic circuit of the sensor circuitry 16₁. The effect that one magnetic circuit has on the other can be used to identify that the devices are in the predetermined intimate physical relationship and also to transfer between the devices their identification data.

In FIG. 4, after the data transfer has taken place, the current in the wire coil 42 can be reversed to repel the two devices thereby indicating to the user that the data transfer has ended.

In FIG. 4, as in FIG. 3, there is a positive physical feedback to the user which includes the physical attraction between the two devices and if the ferro-magnetic cores 40 and 50 are exposed the sound of their touching.

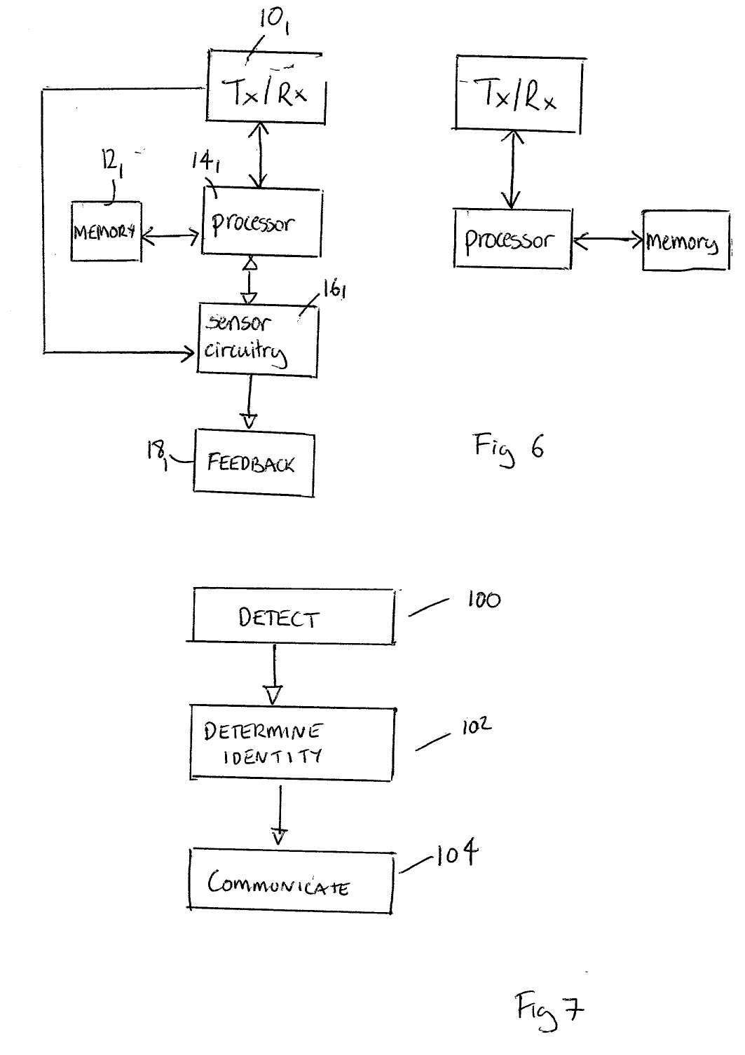

FIG. 5 illustrates a third embodiment of the sensor circuitry 16₁, and the sensor circuitry 16₂. The radio transceiver device 2₁ has an outer surface 60 in which there is a groove 62. The groove 62 is defined by first and second side walls 63 and 64 and a bottom wall 65. The second radio transceiver device 2₂ has an outer surface 70 having a tongue 72. The tongue 72 is defined by first and second side walls 73 and 74 and a top wall 75. The tongue 72 and the groove 62 are dimensioned so that they fit snugly together. The bottom wall 65 of the groove 62 has an electrical contact 66 and the top wall 75 of the tongue 72 also has an electrical contact 76. When the second radio transceiver device 2₂ is brought into a predetermined intimate physical relationship with the radio transceiver device 2₁ the tongue 72 engages the groove 62 and the electrical contact 66 makes contact with the electrical contact 76. Furthermore, the engaging of the tongue and groove gives the user of the radio transceiver device 2₁ a physical feedback indicating their engagement.

Referring to FIG. 5, the electrical contact 66 is connected to drive circuitry 67 and detect circuitry 68 which are in turn connected to control circuitry 69 which has an interface to the processor 14₁. The electrical contact 76 is connected to detect circuitry 78 and drive circuitry 77 which in turn are connected to control circuitry 79 which has an interface to the processor 14₂. The detect circuitry 68 of the radio transceiver device 2₁ detects when contact is made between the electrical contact 66 and the electrical contact 76. The drive circuitry 77 communicates the identification data of the second radio transceiver device 2₂ to detection circuitry 68 which in turn provides it to the control circuitry 69 which in turn provides it to the processor 14₁. The drive circuitry 67 of the radio transceiver device 2₁ provides the identity of the radio transceiver device 2₁ to the second radio transceiver device 2₂ via the detection circuitry 78 and control circuitry 79. The radio transceiver device 2₁ may additionally have feedback circuitry 61 as part of or separate from (but connected to) the sensing circuitry 16₁. The feedback circuitry 61 provides a feedback signal to the user indicating that the identity of the second radio transceiver device 2₂ has been successfully received. The feedback circuitry 61 may for example provide a message on the display, make a noise or cause the radio transceiver device 2₁ to vibrate.

FIG. 6 illustrates a second embodiment of the present invention. The radio transceiver device 2₁ comprises low power radio transceiver circuitry 10₁, a memory 12₁, a processor 14₁, sensor circuitry 16₁ and feedback circuitry 18₁. The second radio transceiver device 2₂ comprises low power radio transceiver circuitry 10₂, a processor 14₂ and a memory 12₂. The processor 14₁ is electrically connected to each of the low power radio transceiver circuitry 10₁, the memory 12₁ and the sensor circuitry 16₁ and it is capable of transmitting and receiving signals to each of these. The sensor circuitry 16₁ is additionally connected to the low power radio transceiver circuitry 10₁ and to the feedback circuitry 18₁.

In this embodiment, the low power radio transceiver circuitry 10₁ has two modes of operation. In a normal mode of operation it operates to communicate with other devices over a range of a few metres or a few tens of metres. In a second reduced power mode of operation it is capable of only communicating with a device over a few centimetres or tens of centimetres. The second reduced power mode of operation is entered in response to a user's input command. In this embodiment, the predetermined intimate physical relationship between the radio transceiver device 2₁ and the second radio transceiver device 2₂ is that they are brought within a distance of a few centimetres or a few tens of centimetres from each other such that the low power radio transceiver circuitry 10₁, when in its low power mode, can communicate with the low power radio transceiver circuitry 10₁ of the second radio transceiver device 2₂. If the low power radio transceiver circuitry 10₁ in its low power mode is capable of communicating with the second radio transceiver device 2₂ this indicates that the devices are in the predetermined intimate physical relationship and the necessary identification data can be transferred between the low power radio transceiver circuitry 10₁ and 10₂. The sensor circuitry 16₁ is connected to the low power radio transceiver circuitry 10₁ and detects when the circuitry has received identification data of the second radio transceiver device 2₂. In response thereto, the sensor circuitry 16₁ enables the feedback circuitry 18₁. The feedback circuitry 18₁ may provide a visual indication on the display, an audio output or it may cause the radio transceiver device 2₁ to vibrate.

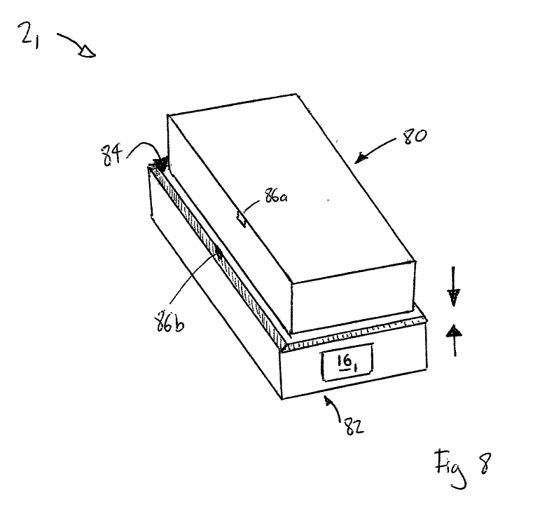

FIG. 7 illustrates a method of transmitting data from a first radio communication device to an intended second radio communications device. The first and second radio communication devices are brought into a predetermined close physical relationship. At step 100 the first radio communication device detects a proximal radio communication device in a predetermined physical relationship to it. Preferably, the first radio communication device automatically, that is without user intervention, moves to step 102. At step 102 the first radio communication device automatically determines the identity of the proximal radio communication device. At step 104 the first radio communication device transmits data by radio to the second (proximal) radio communication device using its previously acquired identity.

According to the Bluetooth standard, a radio transceiver device 2₁ is capable of identifying those devices with which it is capable of communicating with using an Inquiry procedure. This procedure causes the transceiver devices within range to transmit to the transceiver device their identities. Consequently, in this scenario, the memory 12₁ of the radio transceiver device 2₁ will contain the identities of all of the radio transceiver devices within range of the radio transceiver device 2₁. However, it is still necessary for the radio transceiver device 2₁ to identify which one of the plurality of possible radio transceiver devices has been brought into a predetermined intimate physical relationship with it. Consequently when the identity of the second radio transceiver device 2₂ to which the radio transceiver device 2₁ is coupled is transferred to the processor 14₁ it may use this identity to select from the list of Bluetooth addresses stored in the memory 12₁ the Bluetooth address of the second radio transceiver device 2₂. Therefore the radio transceiver device 2₁ is capable of communicating with a plurality of different radio transceiver devices 2ₙ (n=2, 3, 4, 5 & 6 in FIG. 1)but it chooses to communicate only with the device 2₂ with which it is in a predetermined intimate physical relationship.

FIG. 8 illustrates an alternative way in which the first embodiment can be implemented. Instead of having the low power radio transceiver circuitry 10₁, the processor 14₁, the memory 12₁ and the sensor circuitry 16₁ within a body of the radio transceiver device 2₁, the sensor circuitry 16₁ is located in an attachable/detachable cover. In the Figure, the radio transceiver device 2₁ which is of such a size that it can be held in a user's hand, comprises a body portion 80 and a replaceable cover portion 82 having a cavity 84 for receiving and retaining at least a portion of the body 80. The cover 82 comprises sensor circuitry 16₁ and the body 80 comprises the low power radio transceiver circuitry 10₁, the processor 14₁ and the memory 12₁. An electrical connection is formed between an electrical contact 86a of the body 80 and an electrical contact 86b of the cover 82 when the cover 82 is attached to the body 80. The electrical connection connects the sensor circuitry 16₁ to the processor 14₁.

Although the initiation of radio communication between two out of a plurality of radio communication devices has been described by bringing the devices into a predetermined physical relationship, embodiments of the invention extend to the initiation of radio communication between a multiplicity of radio communication devices by bringing the multiplicity of radio communication devices simultaneously or sequrntially into a predetermined physical realtionship.

Although the present invention has been described in the preceding paragraphs with reference to various examples, it should be appreciated that modifications and variations to the examples given can be made without departing from the spirit or scope of the invention.

I claim:

1. A radio communication device comprising: radio communication means for radio communication with any one of a plurality of other radio communication devices; control means for controlling the radio communication means to communicate selectively with a first one of the plurality of other radio communication devices that is or has been aligned with the communication device; and alignment means for physically aligning the radio communication device and the first one of the plurality of other radio communication devices.

2. A radio communication device as claimed in claim 1 further comprising attraction means for attracting the first one of the plurality of other radio communication devices into touching contact with the radio communication device.

3. A radio communication device as claimed in claim 2 wherein the attraction means provides physical feedback to a user of the communication device when it is attracted into touching contact with the first one of the plurality of other radio communication devices.

4. A radio communication device comprising: radio communication means for radio communication with any one of a plurality of other radio communication devices; control means for controlling the radio communication means to communicate selectively with a first one of the plurality of other radio communication devices that is or has been touching the communication device; and attraction means for attracting the first one of the plurality of other radio communication devices, into touching contact with the radio communication device.

5. A radio communication device as claimed in claim 4 wherein the attraction means provides physical feedback to a user of the communication device when it is attracted into touching contact with the first one of the plurality of other radio communication devices.

6. A radio communication device as claimed in claim 4 further comprising alignment means for aligning the radio communication device and the first one of the plurality of other radio communication devices while the radio communication device is attracted into touching contact with the first one of the plurality of other radio communication devices.

7. A method of selecting a first radio communication device from a plurality of radio communication devices for communication with a second communication device, comprising the steps of: a) attracting the first radio communication device and the second radio communication device into touching contact; and b) initiating radio communication between the radio communication devices which are or have been in touching contact.

8. A method of selecting a first radio communication device from a plurality of radio communication devices for communication with a second communication device, comprising the steps of: a) guiding the first radio communication device and the second radio communication device into touching contact; and b) initiating radio communication between the radio communication devices which are or have been in touching contact.

9. A low power radio transceiver device having a communication range, comprising:
radio transceiver means for radio communication with any one of a plurality of radio transceivers within the communication range;
sensing means for sensing the existence of a predetermined physical relationship between the low power radio transceiver device and a first one(s) of the plurality of radio transceivers; and
control means for controlling the radio transceiver means to communicate with only the sensed first one(s) of the plurality of radio transceivers.

10. A low power radio transceiver device as claimed in claim 9, wherein the sensing means comprises identification means for identifying the first one(s) of the plurality of transceivers.

11. A low power radio transceiver device as claimed in claim 9, further comprising feedback means for providing feedback to a user of the low power radio transceiver device and thereby indicating the existence of a predetermined physical relationship between the low power radio transceiver device and a first one of the plurality of transceivers to the user.

12. A low power radio transceiver device as claimed in claim 11 herein the feedback means provides a physical attraction between the low power radio transceiver and a first one of the plurality of transceivers.

13. A low power radio transceiver device as claimed in claim 9 wherein the sensing means comprises a magnetic circuit.

14. A low power radio transceiver device as claimed in claim 13 wherein the sensing means comprises means for identifying the first one of the plurality of transceivers from modulation in the magnetic circuit.

15. A low power radio transceiver device as claimed in claim 13 herein the sensing means comprises means for modulating the magnetic field of the magnetic circuit.

16. A low power radio transceiver device as claimed in claim 15 wherein the means for modulating the magnetic circuit includes means for modulating the current in an inductor.

17. A low power radio transceiver device as claimed in claim 13, further comprising an external surface wherein a portion of the magnetic circuit is exposed on the external surface.

18. A low power radio transceiver device as claimed in claim 9, wherein the sensing means comprises a permanent magnet.

19. A low power radio transceiver device as claimed in claim 9, wherein the sensing means comprises means for producing a magnetic field.

20. A low power radio transceiver device as claimed in claim 9, further comprising an external surface wherein the sensing means comprises a tongue/groove defined in the external surface for engaging with a corresponding groove/tongue of the first one of the plurality of transceivers.

21. A low power radio transceiver device as claimed in claim 20, wherein the sensing means comprises an electrical connection in the tongue/groove.

22. A low power radio transceiver device as claimed in claim 9, wherein the radio transceiver means has a first mode of operation in which the radio transceiver means transmits at a first power and is capable of radio communication with any one of the plurality of radio transceivers within the communication range and has a second mode of operation in which the radio transceiver means transmits at a second power, less than the first power, and is capable of radio communication within a reduced communication range, wherein the sensing means comprises the radio transceiver means operating in the second mode.

23. A low power radio transceiver device as claimed in claim 22, further comprising a header decoder for decoding the header of a radio packet received by the radio transceiver means in the second mode of operation to identify the first one of the plurality of radio transceivers.

24. A low power radio transceiver device as claimed in claim 22, wherein the second reduced communication range is less than 1 m.

25. A low power radio transceiver device as claimed in claim 9, further comprising selection means responsive to the sensing means for selecting from the plurality of radio transceivers, the first radio transceiver wherein the control means responsive to the selection means is arranged to control the radio transceiver means to communicate with the selected one of the plurality of transceivers.

26. A low power radio transceiver device having a communication range, comprising:
radio transceiver circuitry for radio communication with any of a first plurality of radio transceivers within the communication range;
a proximity detector for detecting the closest one of the plurality of radio transceivers; and
control means for controlling the radio transceiver means to communicate with only the closest one of the plurality of radio transceivers.

27. A cover, for a hand held radio communications device having a communication range and comprising: radio transceiver means for radio communication with any one of a plurality of radio transceivers within the communication range; and control means for controlling the radio transceiver means to communicate with a first one of the plurality of radio transceivers, the cover comprising sensing means for sensing a proximal radio transceiver in a predetermined physical relationship with the cover and means for instructing the control means of the hand held communications device to control the radio transceiver means to communicate with the sensed proximal radio transceiver.

28. A method of selecting a first radio communication device from a plurality of radio communication devices for communication with a second communication device, comprising the steps of:
a) bringing the first radio communication device and the second radio communication device into a predetermined close physical relationship;
b) sensing the predetermined close physical relationship between the first radio communication device and the second radio communication device; and
c) initiating radio communication between the radio communication devices in the sensed predetermined close physical relationship.

29. A method as claimed in claim 28, further comprising the step of identifying the first one of the plurality of communication devices.

30. A method as claimed in claim 28, further comprising, after step b), the step of providing physical feedback to a user of the first communication device and/or to a user of the secons communication device.

31. A low power radio transmitter device having a transmission range, comprising:
radio transmitter means for radio transmission to any one of a plurality of radio receivers within the transmission range;
sensing means for sensing the existence of a predetermined physical relationship between the low power radio transmitter device and a first one(s) of the plurality of radio receivers; and
control means for controlling the radio transmitter means to transmit to only the sensed first one(s) of the plurality of radio receivers.

32. A low power radio transmitter device as claimed in claim 31, wherein the sensing means comprises identification means for identifying the first one of the plurality of receivers.

33. A low power radio transmitter device as claimed in claim 31, further comprising feedback means for providing feedback to a user of the low power radio transmitter device and thereby indicating the existence of a predetermined physical relationship between the low power radio transmitter device and a first one of the plurality of receivers to the user.

34. A low power radio transmitter device as claimed in claim 33 wherein the feedback means provides a physical attraction between the low power radio transmitter and the first one of the plurality of receivers.

35. A radio receiver device, comprising:
radio receiver means for radio reception of radio transmissions from any one of a plurality of radio transmitters;
sensing means for sensing the existence of a predetermined physical relationship between the radio receiver device and a first one(s) of the plurality of radio transmitters; and
control means for controlling the radio receiver means to receive radio transmissions from only the sensed first one(s) of the plurality of radio transmitters.

36. A radio receiver device as claimed in claim 35, wherein the sensing means comprises identification means for identifying the first one(s) of the plurality of transmitters.

37. A radio receiver device as claimed in claim 35, further comprising feedback means for providing feedback to a user of the low power radio receiver device and thereby indicating the existence of a predetermined physical relationship between the low power radio receiver device and a first one of the plurality of transmitters to the user.

38. A radio receiver device as claimed in claim 37 wherein the feedback means provides a physical attraction between the radio receiver and the first one of the plurality of transmitters.
